(19) United States
(12) Patent Application Publication
(10) Pub. No.: US 2011/0259127 A1
(43) Pub. Date: Oct. 27, 2011

(54) Sample Collector and Sample Collecting Device for an Analysis Device and Method for the Operation Thereof

(75) Inventors: Sebastian Beer, München (DE); Thomas Ziemann, München (DE); Ulrich Martin, München (DE); Wolfgang Legner, München (DE); Matthias Kessler, München (DE)

(73) Assignee: EADS Deutschland GmbH, Ottobrunn (DE)

(21) Appl. No.: 13/131,315

(22) PCT Filed: Nov. 24, 2009
(86) PCT No.: PCT/EP2009/065719

§ 371 Date: Jul. 7, 2011

(30) Foreign Application Priority Data
Nov. 26, 2008 (DE) 10 2008 059 112.2

(51) Int. Cl. G01N 1/02

(52) U.S. Cl. 73/863.11; 73/864.71

(57) ABSTRACT

A sample collector for an analysis device for analyzing trace elements, including a wiping element on which sample material can be wiped from a surface to be tested and adsorbed thereon by a wiping process, including a support part with a convexly shaped surface to which the wiping element is attached, is provided. A sample collecting device using this sample collector and a method for taking samples are also provided.

### CROSS-REFERENCE TO RELATED APPLICATIONS

The present application is a national stage of PCT International Application No. PCT/DE2009/065719, filed Nov. 24, 2009, and claims priority under 35 U.S.C. §119 to German Patent Application No. 10 2008 059 112.2, filed Nov. 26, 2008, the entire disclosures of which afore-mentioned documents are herein expressly incorporated by reference.

### BACKGROUND AND SUMMARY OF THE INVENTION

The present invention relates to a sample collector and to a sample collecting device for an analysis device for analyzing trace elements, and to a method for its operation.

The detection of trace elements, for example, toxic or explosive substances, is gaining ever more importance in view of the increasing threats from terrorist activity. There are essentially two different methods to distinguish between. The first method involves taking samples from the ambient air by sucking it in, in particular from the vicinity of an object to be examined. This may, for example, be done by taking a person to be examined into a chamber then sucking gas out of it and delivering it for analysis.

The second method is to examine surfaces of an object to be examined, for example a suitcase handle or a human hand, with respect to trace elements adhering thereto. To this end, the surface to be examined is conventionally wiped manually by means of a fabric-like wiping element and possible trace elements are thereby detached from it. The wiping element with the sample material is subsequently placed in a desorbing chamber where the trace elements trapped in the wiping element are desorbed at elevated temperature by means of a gas stream, converted into molecular form and delivered to an analysis device, in particular an ion spectrometer.

The sample collectors, or methods for operating sample collecting devices, used for the latter method have the disadvantage of inherent unreliabilities or measurement inaccuracies. Because of different techniques of wiping by different operators, even the placement of the sample material in the wiping element is undefined, which can lead to the analysis system functioning insufficiently or not at all, if, for example, wiping has been carried out with a fabric edge. The reason is that if the correct point on the wiping element is not exposed to the heat source in the desorbing chamber, trace elements which are actually present cannot be detected or can be detected only insufficiently. Another source of error may result from an incorrect or undetermined arrangement of the wiping element in the desorbing chamber. A further source of error may result from repeated sampling by the same operator, owing to contamination, in particular via the hands. Sample material from prior sampling can remain adhering to the operator's glove and be passed on to the wiping element during subsequent sampling, thereby leading to the false indication of trace elements which are not present.

If an individual rather than an object is to be examined, i.e., a sample of a part of the skin of the person to be examined is intended to be taken by wiping that part of the skin (for example, the hands of the person to be examined), this leads to direct contact between an operator and an individual to be examined, which may be considered harassment. In order to prevent this, the individual to be examined is conventionally requested to carry out the wiping process himself or herself, which also leads to a source of error because the person to be examined does not know how the wiping process should be carried out properly and sometimes it is in their own interest that the trace elements are not detected.

Lastly, when sampling objects there is also a risk of injury for the operators due to concealed sharp or pointed objects or edges and corners.

On the basis of this, it is an object of the invention to provide a sample collector that allows sampling which is as defined and reliable as possible, to present a sample collecting device which allows the most reliable detection possible of the sample adhering to the sample collector, and to provide a method which allows the most reliable sampling possible.

According to the invention, these and other objects are achieved by the features mentioned in the independent claims. Embodiments of the invention and preferred refinements and advantages may be found in the dependent claims, the description and the figures.

According to a first feature of the invention, the sample collector is provided with a support part having a convex surface, to which the wiping element is attached while touching its surface. In connection with the invention, “convex” is intended to mean a geometric shape which is curved in either one direction or two mutually perpendicular directions. Curvature in one direction, in the form of a section of the outside surface of a cylinder, is preferred. During the wiping process, this leads to approximately linear contact on planar surfaces and therefore a narrow sampling region which, when handled by experienced operators, lies approximately in the middle of the wiping element and can therefore be treated in a targeted manner in the subsequent desorption step in the desorbing chamber. This surface shape furthermore allows efficient wiping over a multiplicity of different surface shapes and surface irregularities of the surfaces to be tested. At the same time, the wiping process is simple and easy to standardize, or to teach to operators. Reproducible sampling conditions are also obtained even with different operators.

As an alternative, the support part may also be curved in two directions in order to permit a shape similar to a spherical cap, which allows collection of the sample material on a limited spot.

Owing to the convex surface shape of the support part, the wiping surface of the wiping element is shaped in a defined way and allows concentrated collection of sample material in the small apical region, which normally lies approximately centrally on the wiping element.

The support part may be formed so that it is flexible at least in the apical region, in order to be able to sample irregular surfaces.

According to an advantageous refinement of the invention, the support part essentially consists of a metal plate. This refinement is simple and economical to manufacture and easy to handle, and permits a desorption process in the desorbing chamber at elevated temperatures.

According to an advantageous refinement of the invention, the support plate is provided with a plurality of openings for passing gas through, which is advantageous in particular when a gas is intended to be passed through the wiping element during the desorption process for the purpose of desorbing the sample material. Instead of using a support part with openings, as an alternative the support part may also be made essentially as a grid structure, so as to ensure high gas permeability along the entire surface. As an alternative, the support part may consist of an open-pore metal foam or a rigid metal structure, in the middle of which there is a region consisting of such metal foam.

It is naturally also possible to combine these variants, i.e., to use a support part made of a metal plate and integrate a grid structure in the central region, where the sample material is most likely to accumulate.

The wiping element may consist of a fabric, a nonwoven or an open-pore foam, in order to facilitate the adhesion of trace elements during the wiping process but at the same time allow removal of the sample material during the desorption process in the desorbing chamber.

According to a exemplary refinement of the invention, the support part and the wiping element are firmly connected to one another, i.e., they form an integral unit, which greatly facilitates handling. Thus, such a combined part may be taken from a storage container, then the wiping process is carried out and then this part is put fully into the desorbing chamber. This avoids the essential additional handling steps of conventional systems, which can lead to contamination or errors. After the desorption process, the combined part is removed from the desorbing chamber and disposed of.

According to an advantageous refinement, the sample collector comprises a handle which is fastened to the support part. Such a handle may be an integral component of the sample collector so that the handle, support part and wiping element form a unit which is used and disposed of together. As an alternative, it is also expedient to make the handle removable from the support part, in order to reduce the disposal outlay by the handle being reusable.

A sample collecting device using the sample collector according to the invention permits the advantages already explained above. Such a sample collecting device advantageously comprises an insertion slot which has the cross-sectional shape of the sample collector and thus ensures that it can only be inserted in a clearly defined way. In this case, substantial separation of the sample collection interior from the surroundings can be achieved, so that vitiation of the measurement results by the ambient air can be avoided.

According to an advantageous refinement of this concept, the desorbing chamber comprises a heater which can be operated for defined and continuous heating of the sample material in order to desorb it. This means that the heater is initially switched off and the heater is activated only after the sample collector has been placed inside the desorbing chamber, so as to provide continuous heating of the sample collector and therefore of the sample material. At the same time, a controlled air stream flows through the desorbing chamber and desorbs the sample material from the wiping element, in which case different trace elements are desorbed, and converted into molecular form, at different temperatures by the increasing heating. This heater may be formed as a halogen radiator because it is in this case possible to provide a heater with a simple structure which is highly efficient, and works rapidly.

As an alternative, the heater may also be formed as a hot plate which is then adapted to the shape of the rear side of the support part. When the support part is formed as a curved metal plate, the hot plate has essentially the same shape as the curved support part so that the support part is pressed with the backward side against the hot plate in order to heat it, or the hot plate is moved against the support part with a sample collector mounted fixed inside the desorbing chamber.

According to an advantageous refinement of the invention, the desorbing chamber comprises guiding and supporting elements, by means of which the sample collector can be introduced and placed in a defined way. Using corresponding rails and stops, which are adapted to the shape of the sample collector, the operators can slide the sample collector provided with sample material into the desorbing chamber so that the risk of errors or contamination can be avoided. At the same time, the process is accelerated. Such elements may also comprise configurations which prevent reverse insertion (for example, the wiping element on the wrong side).

For the desorbing chamber, two alternative forms are particularly suitable. In a first embodiment, the support part of the sample collector is not gas-permeable, so that the gas stream which is used to desorb the sample material from the wiping element must be passed along the side with the wiping element. Expediently, the heater is then arranged on the opposite side of the sample collector lying in the desorbing chamber, and therefore heats the sample collector from the rear side. In addition, it is naturally also possible to provide further heaters on the front side of the sample collector, in order to induce direct action of heat on the wiping element, or the sample material trapped in it, from this side as well.

In an alternative embodiment of the desorbing chamber, using a gas-permeable sample collector, the flushing gas for desorbing the sample material from the rear side of the sample collector is passed through the gas-permeable support part and the wiping element, and is then delivered to the analysis unit after emerging from the wiping element. Here as well, the heating element is provided on the rear side of the wiping element in order to act on the gas-permeable support part.

In a method according to the invention for operating a sample collecting device, a sample collector having the features described above is used and is wiped over the surface to be examined, then passed directly to the desorbing chamber in which desorption of the sample material is carried out by heating the sample collector. Because no further steps of handling the sample collector by the operators are necessary, but rather the sample collector can be passed to the desorbing chamber directly after the wiping process, the risk of contamination or measurement errors is substantially avoided in comparison with conventional systems. Additionally, the convex sample collector may be removed perpendicularly to the essentially linear contact area on the surface to be examined, in order to effect sample collection with the greatest possible width.

### BRIEF DESCRIPTION OF THE DRAWING FIGURES

The invention will be explained in more detail below with reference to exemplary embodiments with the aid of the appended drawings, in which:

FIG. 1 shows a perspective representation of a sample collector;

FIG. 2 shows a second perspective representation of the sample collector according to FIG. 1 from the rear side;

FIG. 3 shows an exploded perspective representation of the sample collector according to FIGS. 1 and 2 in the disassembled state;

FIG. 4 shows a schematic sectional representation of a first embodiment of a desorbing chamber;

FIG. 5 shows a schematic sectional representation of a second embodiment of a desorbing chamber.

### DETAILED DESCRIPTION OF THE DRAWING FIGURES

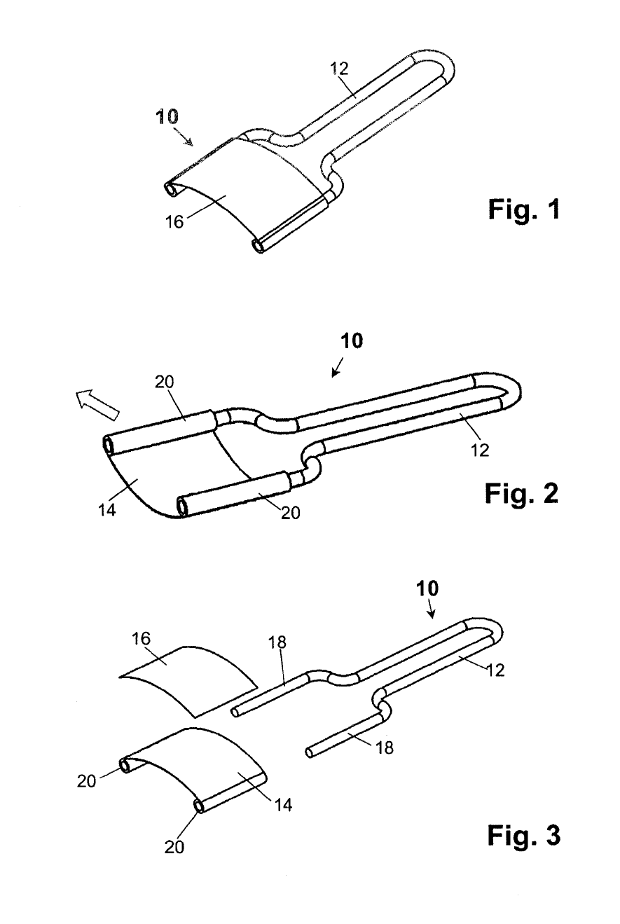

A sample collector 10 is respectively represented in perspective in FIGS. 1 to 3. It comprises a handle 12 on which a curved support part 14 and a wiping element 16 are fitted. In the embodiment shown, the handle 12 comprises a hairpin-shaped holding region and two holding rods 18 which cooperate with guides 20 adapted thereto in the support part 14, in order to provide rapid fastening or removal of the handle 12 to and from the support part 14.

The wiping element 16 is fastened on the convexly shaped upper side of the support part 14. It may either be removable from the support part 14, as represented in FIG. 3, or fastened thereto, for example by adhesive bonding or clamping along the outer edges. For handling, the sample collector 10 is held on the handle 12 by the operator and moved along the arrow shown in FIG. 2, so that the sample material is collected in a narrow region in the middle of the wiping element 16 when it is wiped on a planar surface.

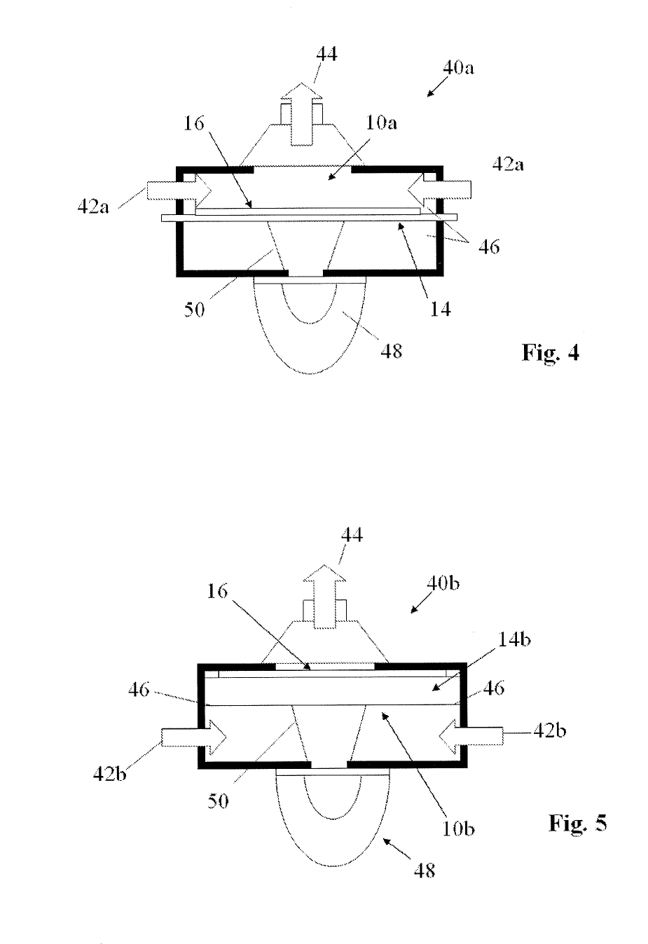

FIG. 4 represents a first embodiment of a desorbing chamber 40a, which comprises gas inlets 42a for the introduction of flushing gas and a gas outlet 44, which is connected to an analysis unit (not shown). The desorbing chamber 40a comprises guides 46 for guiding and supporting a sample collector 10. The sample collector 10 is placed in the desorbing chamber 40a so that the support part 14 is arranged underneath and the wiping element 16 is arranged on top. A halogen heater 48, which transmits radiation 50 onto the support part 14, is arranged below the sample collector 10.

During operation, a sample collector 10 with sample material thereon is inserted into the desorbing chamber 40a with the aid of the guides 46. Heating of the support part 14 by means of the thermal radiation 50 emitted by the halogen heater 48 then takes place, so that the support part 14 is heated to more than 200° C. in a few seconds. This heat is transferred from the support part 14 onto the wiping element 16 and the sample material contained in it, so that the latter is desorbed from the wiping element 16 and converted into molecular gas form. At the same time, the trace elements desorbed from the wiping element 16 are entrained by means of the flushing gas flow taking place from the gas inlets 42a to the gas outlet 44 and delivered for their physical or chemical analysis by the analysis unit (not shown).

The second embodiment of a desorbing chamber 40b, shown in FIG. 5, is constructed very similarly. One difference is that only a gas-permeable sample collector embodiment 10b can be used, in which the support part 14b is gas permeable, consisting of an open-pore metal foam in the embodiment shown.

During operation, a sample collector 10b with sample material thereon is inserted into the desorbing chamber 40b with the aid of the guides 46. Heating of the support part 14b by means of the thermal radiation 50 emitted by the halogen heater 48 then takes place, so that the support part 14 is heated to more than 200° C. in a few seconds. This heat is transferred from the support part 14b onto the wiping element 16 and the sample material contained in it, so that the latter is desorbed from the wiping element 16 and converted into molecular gas form. At the same time, a flushing gas enters the desorbing chamber 40b through the gas inlets 42b, flows through the gas-permeable support part 14b and the wiping element 16 with sample material thereon and thereby desorbs the trace elements of the sample material from the wiping element 16 and delivers them through the gas outlet 44 to the analysis unit (not shown).

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1. A sample collector for an analysis device for analyzing trace elements, comprising a wiping element on which sample material can be wiped from a surface to be tested and adsorbed thereon by a wiping process, wherein said sample collector comprises a support part with a convexly shaped surface, to which the wiping element is attached.

2. The sample collector as claimed in claim 1, wherein the support part is a one-dimensionally curved surface element.

3. The sample collector as claimed in claim 1, wherein the central region of the support part is flexible.

4. The sample collector as claimed in claim 3, wherein the support part has a plurality of openings for passing gas through.

5. The sample collector as claimed in claim 1, wherein the support part is essentially constructed as a grid structure or consists of an open-pore metal foam.

6. The sample collector as claimed in claim 1, wherein the wiping element consists of a fabric, a nonwoven or an open-pore foam.

7. The sample collector as claimed in claim 1, wherein the support part and the wiping element form an integral unit.

8. The sample collector as claimed in claim 1, wherein the sample collector comprises a handle, which is fastened to the support part.

9. The sample collector as claimed in claim 8, wherein the handle can be removed from the support part.

10. A sample collecting device for an analysis device for analyzing trace elements, comprising:
a sample collector including a soft wiping element on which the sample material can be adsorbed by a wiping process and a support part with a convexly shaped surface to which the wiping element is attached; and
a desorbing chamber into which the sample collector can be introduced in order to desorb the sample material and deliver it for analysis of the presence of particular trace elements.

11. The sample collecting device as claimed in claim 10, wherein the desorbing chamber comprises a heater that is operable for continuous heating of the sample collector.

12. The sample collecting device as claimed in claim 11, wherein the heater is a halogen radiator.

13. The sample collecting device as claimed in claim 11, wherein the heater is a hot plate which is adapted to the shape of the rear side of the support part on the other side from the wiping element.

14. The sample collecting device as claimed in claim 10, further comprising a gas feed, by means of which gas for desorbing the sample material from the wiping element is passed through the support part and the wiping element.

15. The sample collecting device as claimed in claim 10, wherein the analysis device is an ion spectrometer.

16. The sample collecting device as claimed in claim 10, wherein the desorbing chamber comprises guiding and supporting elements, by which the sample collector is introduced and placed in a defined way.

17. The sample collecting device as claimed in claim 10, wherein the desorbing chamber comprises a heating device which sends thermal radiation onto the back side of the sample collector and at least one gas feed and one gas outlet are provided on the opposite side of the sample collector from the heating device, by means of which gas can be passed over the wiping element in order to desorb the trace elements.

18. The sample collecting device as claimed in claim 10, wherein the desorbing chamber comprises a heating device which sends thermal radiation onto the back side of the sample collector and a gas feed is provided in the region of the back side of the sample collector and a gas outlet is provided on the opposite side of the sample collector, by means of which gas is fed through the wiping element in order to desorb the trace elements.

19. A method for operating a sample collecting device for an analysis device for analyzing trace elements, including a sample collector having a wiping element, on which the sample material can be adsorbed by means of a wiping process, and a desorbing chamber into which the sample collector is introduced in order to desorb the sample material and analyze the sample material for the presence of particular trace substances, wherein the sample collector, which includes a support part with a convexly shaped surface to which the wiping element is attached, is used and is wiped over the surface to be examined, then passed directly to the desorbing chamber in which desorption of the sample material is carried out by heating the sample collector.

20. The method as claimed in claim 19, wherein the sample collector is moved perpendicularly to its essentially linear contact area on a surface to be examined in order to take up sample material.

21. The method as claimed in claim 19 using a sample collecting device that includes the sample collector, the desorbing device including a heater that is operable for continuous heating of the sample collector, wherein
the sample collector is placed in the desorbing chamber;
the heater is activated and its temperature is increased in a defined way up to a maximum temperature;
a gas is fed across the wiping element and subsequently to an analysis unit, so that sample material is desorbed from the wiping element and delivered to the analysis unit in order to determine the molecular components; and
after the end of the temperature increase, the sample collector is removed from the desorbing chamber.
